(19) United States
(12) Patent Application Publication
(10) Pub. No.: US 2011/0250443 A1
(43) Pub. Date: Oct. 13, 2011

(54) Composite laminate exterior decking material

(76) Inventor: Daniel Michael Schall, Cincinnati, OH (US)

(21) Appl. No.: 12/660,136

(22) Filed: Apr. 12, 2010

(51) Int. Cl. B32B 17/10

(52) U.S. Cl. 428/339

(57) ABSTRACT

A protective composite laminate wood grain appearance material shaped in the form of a channel or flat (but not limited too) that is fasten (glued) on top of the existing (structurally sound but cosmetically damaged by UV rays) treated wooden decking planks. The protective composite laminate wood grained appearance material will beautify and protect existing decks at a fraction of the cost of using replacement solid composite decking planks and or the repetitive maintenance of re-sealing the existing treated wooden deck with stains, water repellants, paint or a facsimile.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

My invention of the composite laminate exterior decking is in the field of composite decking material. I know of no such invention in the this field or specific references to the use of my design, it's application or it's existence in this field.

To my knowledge, the field of composite decking material is made up of solid planking material (see reference U.S. Pat. No. 6,497,937, Current U.S. Class 428/106) and U.S. Pat. No. 5,009,045 Current U.S. Class 52/177). In the case of U.S. Pat. No. 6,497,937, the solid planking is used for structural flooring on vehicle decking, such as trailer floors and U.S. Pat. No. 5,009,045 refers to boat dock decking. Other patents refer to the spraying of a UV blocker that completely covers the wood grain appearance. Neither patents refer to the use of a composite laminate material (wood grain finish) in a channel design, that fits over the top of a residential homes existing exterior treated wood deck.

Treated wood decking planks, rails and sidings are also subjected to a wide range of temperatures, water absorption, wind, rain, ice, snow and insects. No matter what type of wood is used, weather damage to the wood grain finish is inevitable and the beauty of the deck's appearance is destroyed.

Currently, you can re-seal your deck with a variety of stains, preservatives, water repellants, such as Olympic Wood Protector Deck and Fence Stain or Sherwin-Williams line of DeckScapes deck stains. Some of these stains, wood sealers, water repellants, or preservatives, boast some sort of UV protection, but the deck still requires yearly maintenance to keep it's beauty and protect the treated woods structure from warping and splintering.

The cost of yearly sealing, or staining treated wooden deck maintenance (performed by a professional) can run anywhere from $500-$1000, depending on the size of the deck. You could do it yourself, but you would have to rent a pressure washer, purchase deck cleaning liquid, to clean the mold and decolorized stain from the deck. This cleaning could take up to a weekend to do. Then you have to let the deck dry for a few days. Then spend another weekend buying the deck stain, the applicators and re-staining your deck. Just to do it all again next year. The cost of your time, materials and equipment to yearly maintain your decks appearance, could easily top $500.

A second way to protect your treated wooden decking, is to coat it with a paint type sealant that has a solid pigment or tint color that blocks UV rays somewhat but covers the wood grain finish. The beauty of the wood grain finish is gone and it still requires a regular maintenance coat application.

Composite decking planks, rails, posts or steps, is an alternative to the conventional treated wooden deck. However, the cost of each composite decking plank, railing, post or step, can run up to four times the cost of a treated wooden plank. The main reason for this is the composite decking plank, railing, posts or steps, are a solid form (for example: 3½ inch to 11½ inches wide×4 ft to 12 ft. long×1½ thick) made up of expensive Polypropylene, High Density Polyethylene, vinyl, or composite wood, (part plastic and part wood). They are made for structural support as well as cosmetic.

In order to install the composite decking planks, rails and post you have to remove the existing structurally sound (but appearance diminished) treated wooden deck planks, rails, and posts. This could cost over thousands of dollars if professionally done. Or, you could spend (your time) several valuable weekends, renting tools, renting a truck (to haul the composite decking material) and installing it yourself for several thousand dollars.

### SUMMARY OF THE INVENTION

I found it interesting that in the field of treated wood decking products, wood in general that is exposed to the outdoors, or composite decking, does not have an application for the use of a Composite Laminate Exterior decking material that covers the existing wooden deck with a wood grained plastic finish and that completely blocks out any harmful UV rays from damaging the existing treated wood deck material. I also find it interesting that the indoor wooden floor industry (which uses laminate flooring) has not adapted a similar product or this technology to the outdoor wooded decking industry.

And yet, the two most common complaints a home owner has about their wooden decking is the de-colorization, fading or graying of the decks wood grain finish, stained finish, painted or sealed finish, due to UV rays. And the costly expense involved in maintaining it year after year or the costly expense of replacing the treated wooden deck with new treated wood or solid composite decking material.

Most wooden decking material lays horizontal or flat in direct sun light accelerating this weathering damage.

### BRIEF DESCRIPTION OF THE SEVERAL VIEWS OF THE DRAWING

FIG. 1 represents the end view and proposed thickness of the Composite Laminate Exterior Decking material channel. The thickness of the channel can vary from 0.030 of an inch to 0.080 of an inch, but not limited to these thicknesses.

FIG. 2 represents the side view of the Composite Laminate Exterior Decking material channel showing it's varies proposed lengths of 4 ft. To 12 ft. and a height of the channel leg to be 1½ inches, but not limited to these lengths or channel heights.

FIG. 3 represents the top view of the Composite Laminate Exterior Decking material channel showing it's proposed varying widths of 3½ inches to 11½ inches, but not limited to these proposed widths.

### DESCRIPTION OF INVENTION

The Composite Laminate Exterior Decking material is a thin layer (0.030 to 0.080 of an inch in thickness) of Polypropylene, High Density Polyethylene, vinyl, or composite wood, (part plastic and part wood but not limited to them) that is formed or molded in the shape of a channel (but not limited to this shape) that can be placed on top of the existing faded, discolored but structurally sound treated wooden decking, for the purpose of beautifying the decks appearance and protecting the existing treated wooden decking from harmful UV rays.

Current composite decking material is made up of ¾ to 1½ inch thick Polypropylene, High Density Polyethylene, vinyl, or composite wood, (part plastic and part wood but not limited to them) and is sold as planking, railing, posts or steps. This very thick material is extremely expensive (up to four times the cost of treated wooded decking material) and is mainly used for replacing rotted structurally depleted, treated wooden planking, as well as improving the appearance of the deck.

Composite Laminate Exterior Decking material uses this same plastic material technology but in a much thinner, less expensive form and not for structural purposes, only cosmetic.

Treated wooden decking material is under constant exposure of harmful UV rays, weather, rain, snow, and ice. This weathering along with the UV rays can damage the composition of the wood as well as damaging its appearance. Warping, splintering and wood rot are a result of treated wood decking material exposed to the weather. The decking and paint industry has developed wood stains, sealants, water repellants and none of them can stop the forces of nature from damaging your wood decks structural integrity and cosmetic appearance. All of these protectants require maintenance coats or re-applications to slow the effects of nature. Applications and re-applications are expensive and time consuming. Nothing in the decking or paint industry covers the existing structurally sound but cosmetically damaged, treated wood decking, with a thin laminate layer of plastic with a wood grain finish, as in the Composite Laminate Exterior Decking material.

Composite Laminate Exterior Decking uses the same wood grained or tinted Polypropylene, High Density Polyethylene, vinyl, or composite wood, (part plastic and part wood but not limited to them), that is used in the current composite decking. Design a mold that forms a thin channel or shape that conforms to the existing wood decking planks, steps, railing or post. Then fasten this molded plastic shape on top of the existing decking material.

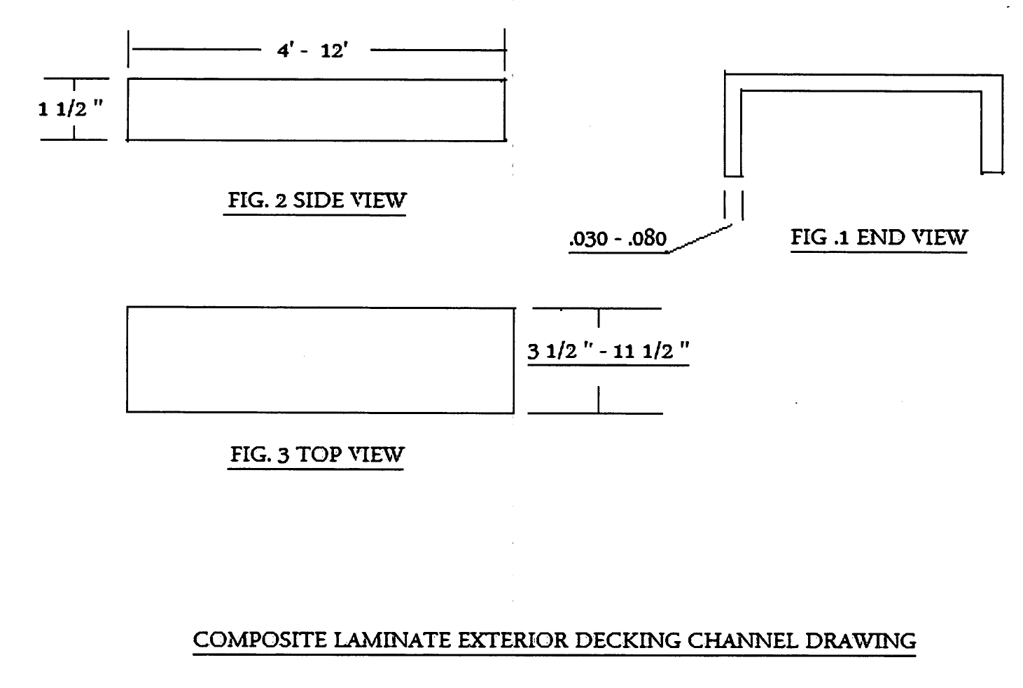

Installation of a Composite Laminate Exterior Decking material (with a wood grain finish) does not require the removal of any of the existing structurally sound treated wooden decking material (as in the case of current composite decking material). This could save the home owner thousands of dollars. The composite laminate exterior decking material (with wood grain finish) can be molded in the form of a thin (0.030 of an inch to 0.080 of an inch thick, see drawing FIG. 1) channel, (but not limited to a channel shape), to fit over any of the existing length or width treated wooden decking planks, railing, posts or steps (see FIGS. 2 and 3 of drawing for most common wood deck material sizes).

This channel design also allows for coverage of the sides of the planks as well as the top surface.

Current composite decking material are fasten with screws and require a drill motor, drills, screws and screwdriver bits to install. This can be time consuming (drilling hundreds of holes in the composite decking, screwing hundreds of screws into them to fasten) and costly (tool rentals, purchasing drill bits and hundreds of special composite decking screws).

The Composite Laminate Exterior Decking material (with a wood grain finish but not limited to a wood grain finish) will be fasten to the existing treated wooden decking material with glue. Gluing would keep the integrity of the Composite Laminate Exterior Decking material in tact (no holes drilled into it for screws), which would allow it to provide a complete covering and protecting of the existing treated wooden deck from UV rays. Simply, measure, cut and glue the Composite Laminate Exterior decking material in place. This will require few tools, speed up the installation process, make it easier for the home owner to install in a weekend and save money.

The Composite Laminate Exterior decking material (with a wood grain finish and limited to a wood grain finish) will come in varies wood grain finishes to match the existing treated wood grain finish. These finishes will permeates the composite laminate exterior decking material making it resistant to UV fading. If the composite laminate exterior decking material were to become blemished. The blemish could easily be removed by pressure washing or with light sanding, restoring the beautiful wood grain deck appearance.

1. A covering for the structurally sound treated wood decking material, comprised of Polypropylene, High Density Polyethylene, vinyl, or composite wood, (part plastic and part wood), formed or molded in a (but not limited to) channel, or flat shape, placed on top of the existing treated wooden decking planks and blocks out all UV rays.

2. A covering for treated wood decking material, that is fasten to the structurally sound existing decking material with glue.

3. A covering for treated wood decking material with a wood grained finish, or any desired colored finish, that permeates the entire thickness of the covering.

4. A covering for treated wood decking material, that can be molded or shaped to cover all existing wooden decking, railing, benches, post and steps.

5. A covering for treated wood decking material that can be formed or molded in varying lengths (but not limited to) of 4 ft. To 12 ft., widths of 3½ inches to 11½ inches.

6. A covering for treated wood decking material that can vary in thickness (but not limited to) 0.030 of an inch to 0.080 of an inch, to allow for UV blockage and fit between decking planks.

7. A covering for treated wood decking material that eliminates the costly replacement of the weathered, splintered, existing wood decking material by blocking out all harmful UV rays. And protects existing treated wood decks from future weather and UV damage.
